(19) United States
(12) Patent Application Publication
(10) Pub. No.: US 2024/0316536 A1
(43) Pub. Date: Sep. 26, 2024

(54) CATALYST FOR DECOMPOSING PERFLUOROCOMPOUNDS AND METHOD OF PREPARING SAME

(71) Applicants: HEESUNG CATALYSTS CORPORATION, Gyeonggi-do (KR); SAMSUNG ELECTRONICS CO., LTD., Gyeonggi-do (KR)

(72) Inventors: Jong-San Chang, Gyeonggi-do (KR); Seongyun Ryu, Chungcheongnam-do (KR); Seungjun Lee, Gyeonggi-do (KR); Joungwoo Han, Seoul (KR); Woosung Choi, Gyeonggi-do (KR); Yongjae Lee, Gyeonggi-do (KR); Jungje Park, Gyeonggi-do (KR); Taewoo Lee, Gyeonggi-do (KR); Hyunsik Han, Seoul (KR)

(21) Appl. No.: 18/603,743

(22) Filed: Mar. 13, 2024

(30) Foreign Application Priority Data
Mar. 24, 2023 (KR) 10-2023-0038550

(51) Int. Cl. B01J 23/30; B01D 53/86; B01J 23/06; B01J 37/02; B01J 37/04; B01J 37/08

(52) U.S. Cl. CPC B01J 23/30; B01D 53/8662; B01J 23/06; B01J 37/0201; B01J 37/0236; B01J 37/04; B01J 37/08; B01D 2255/20776; B01D 2255/20792; B01D 2255/2092; B01D 2257/2066; B01D 2258/0216

(57) ABSTRACT

Proposed are a catalyst for decomposing perfluorocompounds (PFCs) and a method of preparing the same. The provided catalyst for decomposing PFCs and the method of preparing the same are as follows. Zinc as an active component for performance improvement and tungsten (W) as an auxiliary component are added to alumina selected from at least one of gamma alumina, aluminum trihydroxide, boehmite, and pseudo-boehmite, and a weight ratio of Al, Zn, and W is at 100:30 to 100:1 to 11. The catalyst for decomposing PFCs not only has an effect of having durability against fluorine generated by decomposition of PFCs but also has a synergistic effect of improving reaction activity. Furthermore, the catalyst decomposes PFCs at a lower temperature than conventional catalysts for decomposing PFCs. Thus, it is possible to reduce operating costs and secure the durability of the system during continuous operation.

### CROSS REFERENCE TO RELATED APPLICATION

The present application claims priority to Korean Patent Application No. 10-2023-0038550, filed Mar. 24, 2023, the entire contents of which is incorporated herein for all purposes by this reference.

### BACKGROUND OF THE DISCLOSURE

### 1. Field of the Disclosure

The present disclosure relates to the decomposition of perfluorocompounds (PFCs) and, more specifically, to a catalyst for decomposing perfluorocompounds and a method of preparing the same.

### 2. Description of the Related Art

PFCs (CF₄, C₄F₈, CHF₃, CxHyFz) generated in a semiconductor process act as serious greenhouse gases when released into the atmosphere.

TABLE 1

| | | GWP for | GWP for |
|---|---|---|---|
| Greenhouse gas | Lifespan | a 20-year | a 100-year |
| (Chemical formula) | (years) | time horizon* | time horizon |
| Methane (CH₄) | 12.4 | 86 | 34 |
| Nitrous oxide (N₂O) | 121.0 | 268 | 298 |
| Carbon tetrafluoride | 50000 | 4950 | 7350 |
| (CF₄) | | | |

*GWP (Global Warming Potential): Radiative forcing that can absorb and trap greenhouse gases compared to carbon dioxide

A hydrolysis method using a catalyst has been used to treat PFCs contained in waste gases discharged from a semiconductor process. The hydrolysis method is known as a process in which the PFC decomposition reaction proceeds at a high temperature in a range of 700° C. to 900° C. using an alumina catalyst and water vapor. However, in this high-temperature decomposition reaction, the properties of a carrier of the alumina catalyst are converted and the specific surface area of the carrier is reduced, leading to a decrease in active points and finally to a decrease in durability.

### CF₄ Hydrolysis Reaction Mechanism

CF₄+2H₂O→CO₂+4HF(ΔG°=−150 kJ/mol)

### SUMMARY OF THE DISCLOSURE

Therefore, there is a need to improve the durability of a catalyst for decomposing PFCs. In addition, there is a demand in the industry for a catalyst for decomposing PFCs to have an improved conversion rate and improved durability, compared to conventional catalysts for decomposing PFCs. Furthermore, a catalyst for decomposing PFCs with improved activity and durability, and at the same time with optimized shape, size, and strength is needed considering formulation in a PFC decomposition system.

A solution to the problem of the present disclosure is to provide a catalyst for decomposing PFCs with high reaction activity and durability by combining aluminum oxide with zinc (Zn) as an active component for performance improvement and tungsten (W) as an auxiliary component to prepare a W—Zn—Al catalyst.

Without limitation, the precursor of zinc (Zn) applied in the catalyst for decomposing PFCs may be any one selected from zinc nitrate (Zn(NO₃)₂), zincsulfatehydrate (ZnSO₄H₂O), and zincacetate ((CH₃CO₂)₂Zn). The precursors of tungsten (W) may be any one selected from ammonium metatungstate ((NH₄)₆H₂W₁₂O₄O·3H₂O), ammonium paratungstate ((NH₄)₁₀H₂W₁₂O₄₂·4H₂O), sodium tungstate (Na₂WO₄ 2H₂O), tungsten oxide (WO₃), and tungsten chloride (WCl₆), or mixtures thereof. Aluminum oxide may be any one selected from gamma alumina (γ-Al₂O₃), aluminum trihydroxide, boehmite, and pseudo-boehmite.

In addition, the W—Zn—Al catalyst is provided as a catalyst for decomposing PFCs with a weight ratio of Al, Zn, and W at 100:30 to 100:1 to 11.

Another solution to the problem is to provide a catalyst for decomposing PFCs, the catalyst being prepared using an impregnation method, a co-precipitation method, or a physical mixing method as a method of preparing the catalyst.

Yet another solution to the problem is to provide a method for preparing a molded body of a catalyst for decomposing PFCs. The method includes mixing aluminum oxide with zinc (Zn) as an active component for performance improvement and tungsten (W) as an auxiliary component and molding the mixture into one or more of the following shapes: particles, spheres, pellets, and rings.

Yet another solution to the problem is to provide a method for decomposing PFCs, and the method includes introducing water vapor from the outside into the reactor to perform a hydrolysis reaction in a catalyst reactor filled with a molded body of a catalyst for decomposing PFCs.

A catalyst for decomposing PFCs according to the present disclosure has an effect of having durability against fluorine generated by decomposition of PFCs, as well as a synergistic effect of improving reaction activity.

Another effect is that the catalyst for decomposing PFCs of the present disclosure decomposes perfluorocompounds at a lower temperature than conventional catalysts for decomposing PFCs, making it easier to reduce operating costs and ensure the durability of a system during continuous operation, as well as making it possible to miniaturize the system due to the high reaction activity of the catalyst.

### BRIEF DESCRIPTION OF THE DRAWINGS

FIG. 1 illustrates a performance evaluation chart of a catalyst for decomposing PFCs, the catalyst being of alumina combined with zinc (Zn) as an active component for performance improvement and tungsten (W) as an auxiliary component, as obtained in a fresh state of the catalyst and aged state of the catalyst after accelerated evaluation, respectively, when zinc (Zn) is added to alumina as an active component for performance improvement, improvement in the performance of the catalyst is confirmed, and when tungsten (W) is added as an auxiliary component, improvement in the durability of the catalyst is confirmed;

FIG. 2A illustrates a performance evaluation chart corresponding to Zn content in the catalyst, showing the highest conversion rate at a weight ratio of Al and Zn at 100:62 and the lowest conversion rate at a weight ratio of Al and Zn at 100:119, which is determined to be a decrease in performance due to ZnO production, in other words, Zn itself, which is an active component for performance improvement, helps decomposition activity, but the form of ZnO does not seem to help improve performance;

FIG. 2B illustrates an XRD analysis chart corresponding to Zn content in the catalyst, and the ZnO peak is confirmed at a weight ratio of Al and Zn at 100:119, which is determined that the performance deterioration of the catalyst with the weight ratio is due to ZnO production;

FIG. 3A illustrates a performance evaluation chart according to the firing temperature of a mixture with a weight ratio of Al and Zn at 100:62, and the higher the firing temperature, the higher the conversion rate, which is determined to be a performance difference due to the ZnAl₂O₄/ZnO ratio;

FIG. 3B illustrates an XRD analysis chart according to the firing temperature of a mixture with a weight ratio of Al and Zn at 100:62, and the higher the firing temperature, the higher the ZnAl₂O₃ formation rate;

FIG. 4 illustrates a durability evaluation chart for a catalyst sample with a weight ratio of Al and Zn at 100:62, and the accelerated evaluation indicated in the chart was made after deactivating the catalyst through an HF acid treatment process, compared to a conventional A catalyst, the conversion rate of the catalyst of the present disclosure was improved at all conversion temperatures in a fresh state and aged state after accelerated evaluation, respectively, compared to the conventional catalyst, the catalyst sample in the fresh state shows a 32% performance improvement while in the aged state or the deteriorated state, the performance is improved by 6%, but a performance reduction rate due to deterioration is reduced to 61% for the catalyst sample compared to 49% for the conventional catalyst;

FIG. 5A illustrates a design chart of auxiliary components to reduce a performance reduction rate due to deterioration with a catalyst sample with a weight ratio of Al, Zn, and M at 100:63:11 in which M is any one from cobalt, nickel, tungsten, zirconium, or molybdenum, and it is confirmed that especially at 700° C., the auxiliary component W improves the durability of the catalyst against HF without reducing the initial performance;

FIG. 5B illustrates a chart measuring a performance reduction rate corresponding to the content of tungsten which is an auxiliary component, when 7% by weight of tungsten is added, based on 100% by weight of Al, the performance reduction rate is minimal, and when more tungsten is added, the performance reduction rate worsens;

FIG. 6 illustrates a performance evaluation chart of a conventional catalyst for decomposing PFCs and a catalyst for decomposing PFCs of the present disclosure; and

FIG. 7 illustrates a chart evaluating the performance of a conventional catalyst for decomposing PFCs and a catalyst for decomposing PFCs of the present disclosure before and after accelerated evaluation.

### DESCRIPTION OF THE PREFERRED EMBODIMENTS

### Definition

Perfluorocompounds may include carbon-containing PFCs, nitrogen-containing PFCs, and sulfur-containing PFCs which all contain two or more fluorine (F). Carbon-containing PFCs may include cyclic aliphatic and aromatic perfluorocarbons, as well as saturated and unsaturated aliphatic components such as CF₄, CHF₃, CH₂F₂, C₂F₄, C₂F₆, C₃F₆, C₃F₈, C₄F₈, and C₄F₁₀. Nitrogen-containing PFCs may typically include NF₃, and sulfur-containing PFCs may include SF₄ and SF₆. Furthermore, PFCs may even include compounds that can be decomposed by a catalyst to form gaseous products such as HF.

An acid gas referred to herein is a gas that becomes acidic when in contact with water, and non-limiting examples thereof include halogen, hydrogen halide, nitrogen oxides (NOx), sulfur oxides (SOx), acetic acid, sublimated mercury, hydrogen sulfide, and carbon dioxide. The acid gas not only causes corrosion but can also reduce the activity of the catalyst.

A hydrolysis reaction that occurs between PFCs and moisture is an endothermic reaction. Accordingly, the hydrolysis reaction can induce a spontaneous reaction, which means the higher the temperature, the easier it is to decompose PFCs. Thus, PFC decomposition progresses faster. However, the thermal stability of the catalyst decreases due to high temperature. In other words, the operating conditions at a temperature in a range of 700° C. to 900° C. are high-temperature conditions for the catalyst to maintain activity for a long time without physical or chemical changes, so securing the durability of the catalyst is the biggest problem. In particular, there is a need to develop a catalyst that continues to be durable in a reaction atmosphere at a temperature in a range of 700° C. to 900° C. where both HF and water vapor generated as by-products exist.

The present disclosure provides a catalyst for decomposing PFCs that has excellent decomposition activity and durability for PFCs used in a semiconductor manufacturing process and can maintain catalytic activity for a long time. The present disclosure relates to a catalyst for decomposing PFCs that has an excellent performance in decomposing perfluorocompounds even at low temperatures, making it easy to reduce operating costs and ensure system durability during continuous operation.

Various embodiments are presented to achieve the objectives of the present disclosure.

A first embodiment of the present disclosure relates to a catalyst for decomposing PFCs. In the catalyst, zinc as an active component for performance improvement and tungsten (W) as an auxiliary component are added to an alumina precursor selected from at least one of gamma alumina, aluminum trihydroxide, boehmite, and pseudo-boehmite. The catalyst has a weight ratio of Al, Zn, and W at 100:30 to 100:1 to 11.

A second embodiment of the present disclosure presents a method in which an aqueous solution of a zinc precursor and tungsten (W) precursor dissolved in distilled water is mixed with at least one alumina precursor selected from gamma alumina, aluminum trihydroxide, boehmite, and pseudo-boehmite, followed by drying and mixing to prepare a Zn—W—Al catalyst.

The Zn—W—Al catalyst has a weight ratio of Al, Zn, and W at 100:30 to 100:1 to 11.

A third embodiment of the present disclosure provides a method for treating perfluorocompounds, including decomposing PFCs in a perfluorocompound-containing gas using the catalyst for decomposing PFCs of the first embodiment.

A fourth embodiment of the present disclosure relates to a semiconductor manufacturing process including decomposing a perfluorinated compound in a perfluorocompound-containing gas using the catalyst for decomposing PFCs of the first embodiment.

The precursors of zinc (Zn) in the catalyst for decomposing PFCs may be any one selected from zincnitrate (Zn(NO₃)₂), zincsulfatehydrate (ZnSO₄H₂O), and zincacetate (CH₃CO₂)₂Zn). The precursors of tungsten (W) may be any one selected from ammonium metatungstate ((NH₄)₆H₂W₁₂O₄₀·3H₂O), ammonium paratungstate ((NH₄)₁₀H₂W₁₂O₄₂·4H₂O), sodium tungstate (Na₂WO₄·2H₂O), tungsten oxide (WO₃), and tungsten chloride (WCl₆), or mixtures thereof. Alumina may be any one selected from alpha alumina, gamma alumina (γ-Al₂O₃), aluminum trihydroxide, boehmite, and pseudo-boehmite.

One example of a catalyst for decomposing PFCs is to prepare a catalyst for decomposition by combining alumina, zinc, and tungsten to the weight ratio of Al, Zn, and W at 100:30 to 100:1 to 11 after impregnating gamma alumina with zinc and tungsten precursors sequentially or simultaneously. The method for preparing the catalyst for decomposing PFCs is any one selected from an impregnation method, a co-precipitation method, and a physical mixing method.

In the catalyst for decomposing PFCs, γ-alumina is preferred as a support or carrier working with an active component for performance improvement and auxiliary component. In addition, when the transition of γ-alumina to the c phase can be suppressed, there is a synergistic effect of maintaining a high PFC decomposition ability of the catalyst for a long time.

When zinc (Zn) is added as an active metal for performance improvement, desirable results can be given in terms of improvement in conversion rate during the PFC catalytic decomposition reaction. Additionally, durability is greatly improved when tungsten (W) is impregnated as a co-catalyst or auxiliary component.

The catalyst for decomposing PFCs prepared is dried at a temperature in a range of 150° C. or higher and can be fired in an air atmosphere at a temperature in a range of 600° C. to 900° C. The final shape of the catalyst may be a granular shape such as a sphere, pellet, or ring, or may be molded into a honeycomb.

The catalyst for decomposing PFCs exhibits excellent decomposition effect and durability in decomposing and removing perfluorocompounds containing halogen acid gases. Therefore, the catalyst can be used in processes containing halogen acid gases, especially to decompose perfluorocompounds used in the semiconductor manufacturing industry.

The temperature during the PFC catalytic decomposition reaction is in a range of 600° C. to 800° C., preferably 650° C. to 750° C.

To perform a hydrolysis reaction in the catalytic reactor, water may be introduced into the reactor from the outside. Water may be supplied through a separately provided source outside the reactor, and may be supplied in the form of water vapor before flowing into the reactor. Preferably, pure water is used as the water supplied into the reactor, and the supply amount can be adjusted considering the hydrolysis reaction rate.

Hereinafter, the catalyst will be prepared in detail and the effects of the prepared catalyst will be described.

### Example 1

### Preparation of Zn—Al Catalyst (Al:Zn=100:31 Weight Ratio)

A solution of 63 g of zincnitrate in distilled water was mixed with 83 g of aluminum oxide, dried at a temperature of 150° C. for 3 hours, and fired at a temperature of 750° C. for 10 hours.

### Example 2

### Preparation of Zn—Al Catalyst (Al:Zn=100:62 Weight Ratio)

A solution of 107 g of zincnitrate in distilled water was mixed with 71 g of aluminum oxide, dried at a temperature of 150° C. for 3 hours, and fired at a temperature of 750° C. for 10 hours.

### Example 3

### Preparation of Zn—Al Catalyst (Al:Zn=100:119 Weight Ratio)

A solution of 162 g of zincnitrate in distilled water was mixed with 56 g of aluminum oxide, dried at a temperature of 150° C. for 3 hours, and fired at a temperature of 750° C. for 10 hours.

### Example 4

### Preparation of W—Zn—Al Catalyst (Al:Zn:W=100:62:11 Weight Ratio)

A solution of 5.5 g of ammoniummetatungstate dissolved in distilled water was mixed with 95 g of the catalyst prepared in Example 2, dried at a temperature of 150° C. for 3 hours, and fired at a temperature of 750° C. for 10 hours.

### Comparative Example 1

### Preparation of Co—Zn—Al Catalyst (Al:Zn:Co=100:62:11 Weight Ratio)

A Co—Zn—Al catalyst was prepared in the same manner as in Example 4, except that 20 g of cobaltnitrate was dissolved in distilled water instead of ammoniummetatungstate.

### Comparative Example 2

### Preparation of Ni—Zn—Al Catalyst (Al:Zn:Ni=100:62:11 Weight Ratio)

A Ni—Zn—Al catalyst was prepared in the same manner as in Example 4, except that 20 g of nickelnitrate was dissolved in distilled water instead of ammoniummetatungstate.

### Comparative Example 3

### Preparation of Zr—Zn—Al Catalyst (Al:Zn:Zr=100:62:11 Weight Ratio)

A Zr—Zn—Al catalyst was prepared in the same manner as in Example 4, except that 17 g of zirconiumacetate was dissolved in distilled water instead of ammoniummetatungstate.

### Comparative Example 4

### Preparation of Mo—Zn—Al Catalyst (Al:Zn:Mo=100:62:11 Weight Ratio)

A Mo—Zn—Al catalyst was prepared in the same manner as in Example 4, except that 6 g of ammoniummolybdate was dissolved in distilled water instead of ammoniummetatungstate.

### Example 5

### Preparation of W—Zn—Al Catalyst (Al:Zn:W=100:62:2 Weight Ratio)

A solution of 1.1 g of ammoniummetatungstate dissolved in distilled water was mixed with 99 g of the catalyst prepared in Example 2, dried at a temperature of 150° C. for 3 hours, and fired at a temperature of 750° C. for 10 hours.

### Example 6

### Preparation of W—Zn—Al Catalyst (Al:Zn:W=100:62:7 Weight Ratio)

A solution of 3.3 g of ammoniummetatungstate dissolved in distilled water was mixed with 97 g of the catalyst prepared in Example 2, dried at a temperature of 150° C. for 3 hours, and fired at a temperature of 750° C. for 10 hours.

### Example 7

### Preparation of W—Zn—Al Catalyst (Al:Zn:W=100:62:7 Weight Ratio)

A solution of 102 g of zincnitrate and 3.3 g of ammoniummetatungstate dissolved in distilled water was mixed with 69 g of aluminum oxide, dried at a temperature of 150° C. for 3 hours, and fired at a temperature of 750° C. for 10 hours.

### Experiment Example 1

To compare the removal efficiency of perfluorocompounds (CF₄) by the catalysts prepared in the Examples and Comparative Examples, the performance was evaluated under the following experimental conditions.

18 ml of each of the catalysts prepared in Examples and Comparative Examples were taken and filled in a 1-inch Inconel reaction tube. The reaction temperature was adjusted to 700° C. using an external heater. 2000 ppm of tetrafluoromethane (CF₄) was decomposed by each of the catalyst samples at a space velocity of 17,000 h⁻¹ and in an atmosphere of 6% oxygen (O_{2), and} 10% water (H₂O). The tetrafluoromethane removal efficiency was calculated using Equation 1 below, and the reactant was analyzed using FT-IR.

CF₄ removal efficiency(%)═(CF₄ concentration at reactor inlet−CF₄ concentration at reactor outlet)/CF₄ concentration at reactor inlet*100 <Equation 1>

### Experiment Example 2

Accelerated evaluation (in an aged state of the catalysts) was evaluated under the same experimental conditions after treating the prepared catalysts in a hydrofluoric acid (HF) solution for 3 hours followed by drying and re-firing.

The evaluation results are summarized in Tables 2 and 3.

TABLE 2

| | CF₄ removal efficiency % | | | | | | |
|---|---|---|---|---|---|---|---|
| | Example 1 | Example 2 | Example 3 | Example 4 | Example 5 | Example 6 | Example 7 |
| Fresh | 71 | 83 | 69 | 82 | 79 | 80 | 80 |
| Aged | | 32 | | 43 | 50 | 54 | 54 |

TABLE 3

| | CF₄ removal efficiency % | | | | | |
|---|---|---|---|---|---|---|
| | | | Comparative | Comparative | Comparative | Comparative |
| | Example 2 | Example 4 | Example 1 | Example 2 | Example 3 | Example 4 |
| Fresh | 83 | 82 | 68 | 68 | 67 | 42 |
| Aged | 32 | 43 | 28 | 28 | 37 | 31 |

Hereinafter, the design process and evaluation results for selecting the active components for performance improvement and auxiliary components according to the present disclosure will be described with reference to the tables and drawings below.

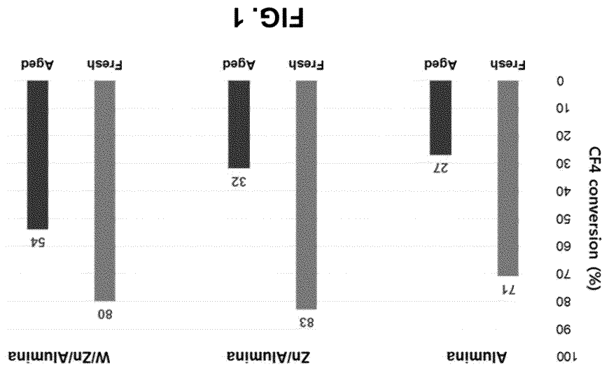

FIG. 1 illustrates a performance evaluation chart of a catalyst for decomposing PFCs, the catalyst serving as a carrier of alumina combined with zinc (Zn) as an active component for performance improvement and tungsten (W) as an auxiliary component, as obtained in a fresh state of the catalyst and aged state of the catalyst after accelerated evaluation, respectively. The present inventors found that adding zinc (Zn) to alumina as a component for improvement improved the CF₄ conversion rate from 71% to 83%, and at the same time, adding tungsten (W) as an auxiliary component improved durability performance from 27% to 54% as a conversion rate, and thus, the inventors determined zinc as an active component for performance improvement and tungsten as an auxiliary component, respectively.

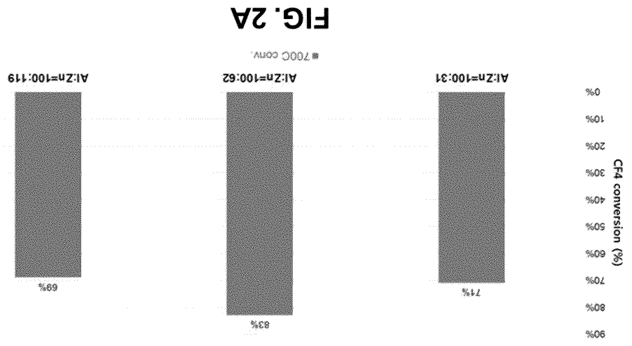

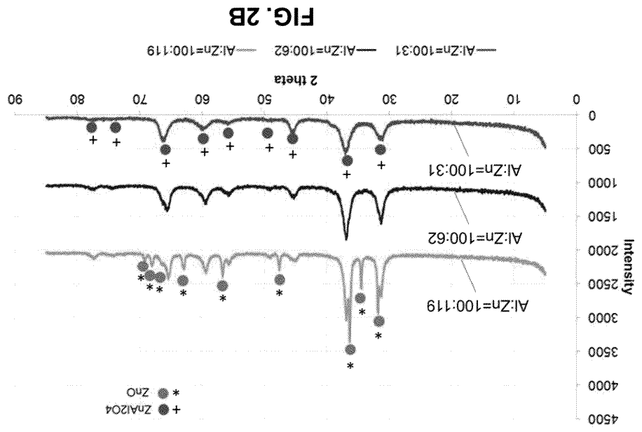

FIG. 2A illustrates a performance evaluation chart corresponding to Zn content, showing the highest conversion rate at a content ratio of 62% by weight of Zn to 100% by weight of Al, and a low conversion rate at a content ratio of 119% by weight of Zn to 100% by weight of Al, which was a decrease in performance due to ZnO production, in other words, Zn itself was considered to have a positive effect on decomposition activity, but the ZnO form was judged to harm performance improvement, and performance evaluation conditions were the same as in FIG. 1.

FIG. 2B illustrates an XRD analysis chart corresponding to Zn content in the catalyst, and the ZnO peak was confirmed when 119% by weight of Zn was added, based on 100% by weight of Al, and thus, it was determined that the performance deterioration of the catalyst with the weight ratio is due to ZnO production.

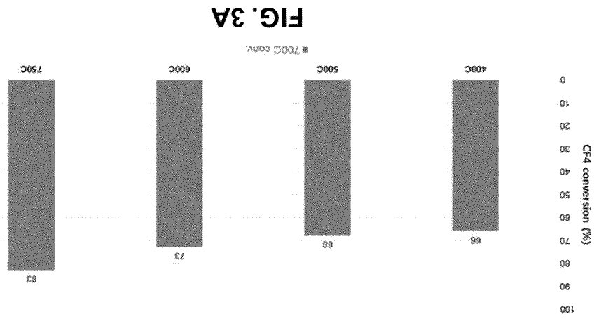

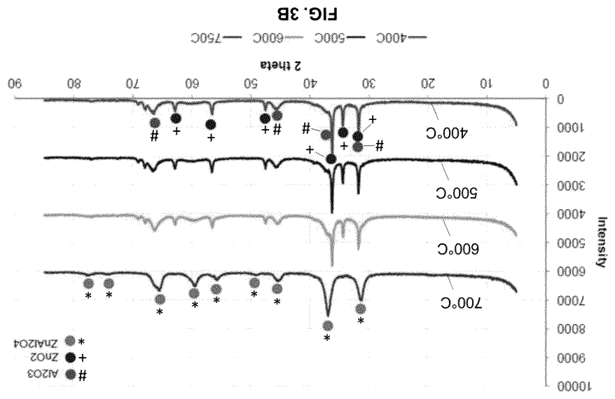

FIG. 3A illustrates a performance evaluation chart according to the firing temperature of a zinc precursor and alumina mixture at a content ratio of 62% by weight of Zn to 100% by weight of Al, and the higher the firing temperature, the higher the conversion rate, which was determined to be a performance difference due to the ZnAl₂O₄/ZnO ratio.

FIG. 3B illustrates an XRD analysis chart according to the firing temperature of a zinc precursor and alumina mixture at a content ratio of 62% by weight of Zn to 100% by weight of Al, and the higher the firing temperature, the higher the ZnAl₂O₄ formation rate.

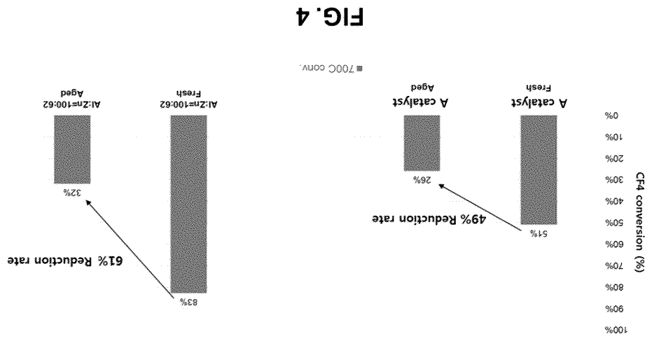

FIG. 4 illustrates a durability evaluation chart for a catalyst sample with 29% by weight of Zn added as an active component for performance improvement, based on 100% by weight of Al, and compared to a conventional A catalyst, the conversion rate of the catalyst of the present disclosure was improved at all conversion temperatures in a fresh state and aged state after accelerated evaluation, respectively, and compared to the conventional catalyst, the catalyst sample in the fresh state showed a 32% performance improvement, and in the aged state or the deteriorated state, the performance was improved by 6%, but the performance reduction rate due to deterioration was reduced to 61% for the catalyst sample compared to 49% for the conventional catalyst, and thus, the addition of auxiliary components was considered to reduce the performance reduction rate due to deterioration.

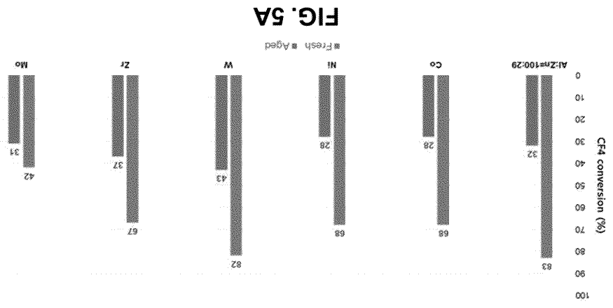

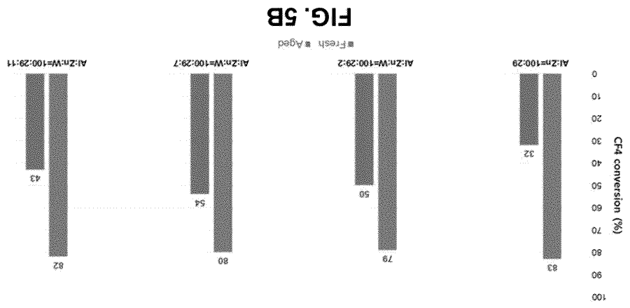

FIG. 5A illustrates a design chart of auxiliary components to reduce the performance reduction rate due to deterioration, and catalyst performance and durability against HF were evaluated by adding 11% by weight of each of cobalt, nickel, tungsten, zirconium, or molybdenum to an Al—Zn catalyst at a content ratio of 62% by weight of Zn to 100% by weight of Al. In particular, the auxiliary component W improved deterioration-induced durability.

FIG. 5B illustrates a chart measuring a performance reduction rate corresponding to the content of tungsten, which is an auxiliary component, and when 7% by weight of tungsten was added, based on 100% by weight of Al, the performance reduction rate was minimal, and when more tungsten was added, the performance reduction rate worsened.

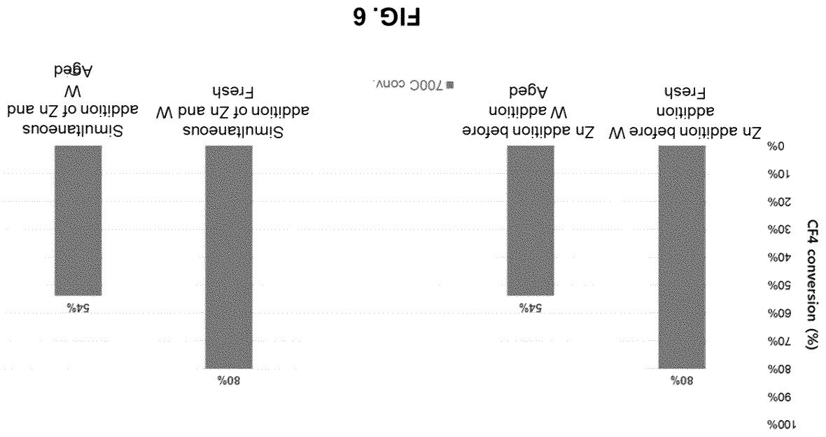

FIG. 6 illustrates a method of adding zinc as an active component for performance improvement, and tungsten as an auxiliary component and illustrates that adding two components at the same time was no different from adding the two components step by step.

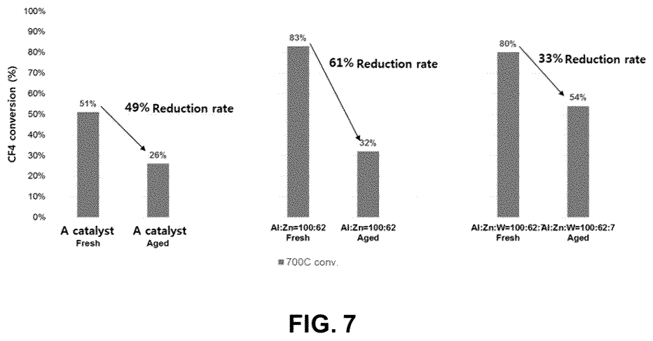

FIG. 7 illustrates a chart evaluating the performance of a conventional catalyst for decomposing PFCs and a catalyst for decomposing PFCs of the present disclosure before and after accelerated evaluation.

Referring to the described examples and experiment examples, the aluminum oxide catalyst for decomposing PFCs and a method of preparing the same according to the examples of the present disclosure can improve decomposition efficiency and durability for PFCs, and although the present disclosure has been described with reference to preferred examples, it will be understood that those skilled in the art can make various modifications and changes to the present disclosure without departing from the spirit and scope of the present disclosure disclosed in the claims below.

What is claimed is:

1. A catalyst for decomposing PFCs comprising alumina selected from at least one of gamma alumina, aluminum trihydroxide, boehmite, and pseudo-boehmite, the alumina being added with zinc as an active component for performance improvement and tungsten (W) as an auxiliary component, in which a weight ratio of Al, Zn, and W is at 100:30 to 100:1 to 11.

2. A method of preparing a catalyst for decomposing PFCs, the method comprising: mixing an aqueous solution of zinc (Zn) precursor dissolved in distilled water with an alumina precursor or alumina selected from at least one of gamma alumina, aluminum trihydroxide, boehmite, and pseudo-boehmite to achieve a weight ratio of Al, Zn, and W at 100:30 to 100:1 to 11 in a final catalyst for decomposing PFCs, followed by drying and firing; and
mixing the mixture with an aqueous solution of tungsten (W) precursor, followed by drying and firing.

3. A method of preparing catalyst for decomposing PFCs, the method comprising mixing an aqueous solution of both zinc (Zn) precursor and tungsten (W) precursor dissolved in distilled water with at least one alumina precursor or alumina selected from gamma alumina, aluminum trihydroxide, boehmite, and pseudo-boehmite to achieve a weight ratio of Al, Zn, and W at 100:30 to 100:1 to 11 in a final catalyst for decomposing PFCs, followed by drying and firing.

4. The method of claims 2 and 3, wherein the zinc (Zn) precursor is zincnitrate (Zn(NO₃)₂), zincsulfatehydrate (ZnSO₄H₂O), or zincacetate ((CH₃CO₂)₂Zn), and the tungsten (W) precursor is any one selected from ammonium metatungstate ((NH₄)₆H₂W₁₂O₄₀·3H₂O), ammonium paratungstate ((NH₄)₁₀H₂W₁₂O₄₂·4H₂O), sodium tungstate, tungsten oxide, and tungsten chloride, or a mixture thereof.

5. A method of treating PFCs, the method comprising decomposing PFCs in a PFC-containing gas using the catalyst for decomposing PFCs of claim 1, and a decomposition temperature is in a range of 600° C. to 800° C.

6. The method of claim 4, wherein the method of treating PFCs is applied in a semiconductor manufacturing process.
